(19) United States
(12) Patent Application Publication
(10) Pub. No.: US 2017/0264973 A1
(43) Pub. Date: Sep. 14, 2017

(54) Video playing method and electronic device

(71) Applicants: Le Holdings (Beijing) Co., Ltd., Beijing (CN); LE SHI INTERNET INFORMATION & TECHNOLOGY CORP., BEIJING, Beijing (CN)

(72) Inventor: Yuanhang Ren, Beijing (CN)

(21) Appl. No.: 15/244,175

(22) Filed: Aug. 23, 2016

Related U.S. Application Data
(63) Continuation of application No. PCT/CN2016/088060, filed on Jul. 1, 2016.

(30) Foreign Application Priority Data
Mar. 14, 2016 (CN) 201610143345.1

(51) Int. Cl. H04N 21/81; H04N 21/435; H04N 21/414; G11B 27/34

(52) U.S. Cl. CPC H04N 21/8133; G11B 27/34; H04N 21/435; H04N 21/41407

(57) ABSTRACT

This application discloses a method and electronic device for video playing, and relates to the field of video analysis technology, wherein the method for video playing comprises the following steps: determining whether a current frame comprises marker information with respect to a target object in a video playing process; highlighting brief information of the target object in the current frame when the current frame comprises the marker information with respect to the target object; determining whether a request for displaying detailed information of the target object is received; and displaying the detailed information of the target object when the request for displaying the detailed information of the target object is received. This application has achieved the effect of displaying the contents of marker information in a video playing process, thereby greatly facilitating a user to search information appearing in the video and improving the convenience.

### CROSS REFERENCE

This application is a continuation of International Application No. PCT/CN2016/088060 filed on Jul. 1, 2016, which is based upon and claims priority to Chinese Patent Application No. 201610143345.1, filed on Mar. 14, 2016, and the entire contents of which are incorporated herein by reference.

### TECHNICAL FIELD

The embodiments of this application relate to the field of video analysis technology, particularly to a method and electronic device for video playing.

### BACKGROUND

In the prior art, due to the advantages, e.g. mobility and portability, of intelligent terminals (such as smart phones, PADs, etc.), most of users will choose to watch videos on intelligent terminals. When watching videos, users will usually feel that a place or some places (scenarios) have amazing landscapes and want to visit the place(s), or may be crazy about celebrities in the videos and want to pay close attention to them, or may feel that some clothes, shoes, bags, jewelry or the like therein are very beautiful and want to know details about them.

However, at present, information regarding place, character, costume and the like in a video cannot be provided along with the video playing. When a user wants to pay special attention to some information presenting in a video, the user needs to search information (e.g. introduction) of the video, which is very unintelligent. Sometimes, the user may obtain information regarding place, character, costume and the like from the introduction of the video and then speculates and obtains information to which the user want to pay close attention therefrom. But sometimes, the user may fail to obtain information to which the user wants to pay close attention after prolonged search. For example, after obtaining information of a concerned place, a user still needs to contact with a travel agency by itself to book air tickets, hotels, etc., which is very time-consuming and labor-consuming.

### SUMMARY

Therefore, the embodiments of this application can solve the technical problem that concerned important information cannot be displayed in a video playing process in the prior art.

One objective of the embodiments of this application is to provide a method for video playing, including the following steps: determining whether a current frame includes marker information with respect to a target object in a video playing process; highlighting brief information of the target object in the current frame when the current frame includes the marker information with respect to the target object; determining whether a request for displaying detailed information of the target object is received; and displaying the detailed information of the target object when the request for displaying the detailed information of the target object is received.

This application also provides an electronic device, including at least one processor, and a memory in communication connection with the at least one processor, where the memory stores instructions that can be executed by the at least one processor, and the instructions are executed by the at least one processor to enable the at least one processor to: determine whether a current frame includes marker information with respect to a target object in a video playing process; highlight brief information of the target object in the current frame when the current frame includes the marker information with respect to the target object; determine whether a request for displaying detailed information of the target object is received; and display the detailed information of the target object when the request for displaying the detailed information of the target object is received.

Another objective of the embodiments of this application is to provide a non-volatile computer storage medium storing computer executable instructions, where, the computer executable instructions, when executed by the electronic device, enable the electronic device to: determine whether a current frame includes marker information with respect to a target object in a video playing process; highlight brief information of the target object in the current frame when the current frame includes the marker information with respect to the target object; determine whether a request for displaying detailed information of the target object is received; and display the detailed information of the target object when the request for displaying the detailed information of the target object is received.

### BRIEF DESCRIPTION OF THE DRAWINGS

In order to illustrate the technical solution in specific implementations of this application more clearly, the accompany drawings to be used in the description of specific implementations will be briefly introduced as follows. Apparently, the accompanying drawings described below are some embodiments of this application. For those skilled in the art, other drawings may also be concluded according to these drawings without inventive efforts.

FIG. 1 is a flow chart of a specific example of a method for video playing in accordance with Embodiment 1 of this application;

FIG. 2 is a flow chart of another specific example of a method for video playing in accordance with Embodiment 1 of this application;

FIG. 3 is a flow chart of another specific example of a method for video playing in accordance with Embodiment 1 of this application

FIG. 4 is a functional block diagram of a specific example of a device for video playing in accordance with Embodiment 2 of this application; and

FIG. 5 is a schematic diagram of a hardware structure of an electronic device in Embodiment 4 of this application.

### DETAILED DESCRIPTION OF THE EMBODIMENTS

To make the objectives, the technical solution and the advantages of the embodiments of this application clearer, the technical solution of this application will be clearly and completely described hereinafter through implementation with reference to the accompanying drawings in the embodiments of this application. Apparently, the embodiments described below are a part, but not all, of the embodiments of this application.

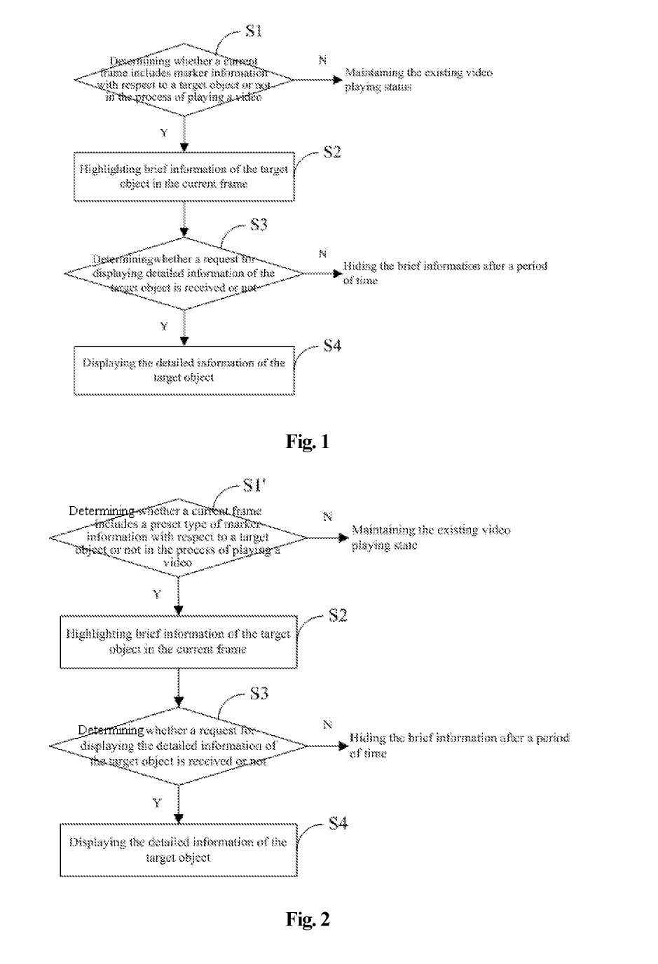

The embodiment provides a method for video playing, as shown in FIG. 1, including the following steps:

S1, determining whether a current frame includes marker information with respect to a target object in a video playing process. Optionally, the type of the marker information includes at least one of place type, character type and costume type. When the current frame includes the marker information with respect to the target object, step S2 will be executed; or when the marker information is not included, the existing video playing state will be maintained. The marker information may be input in advance in the process of uploading a video.

S2, highlighting brief information of the target object in the current frame.

Optionally, the brief information of marker information of a place type includes place names and the like; the brief information of marker information of a character type includes people's names and the like, and the brief information of marker information of a costume type includes brands and the like. Optionally, highlighting means to display in the form of watermark.

S3, determining whether a request for displaying detailed information of the target object is received.

When the request for displaying the detailed information of the target object is received, step S4 will be performed; or when the request for displaying the detailed information of the target object is not received, displaying of the brief information will be maintained for a period of time and then the brief information will be hidden. Optionally, the request includes one or more of a signal generated by clicking on a scenario region in the current frame, a signal generated by clicking on a character region in the current frame and a signal generated by clicking on a costume region in the current frame.

S4, displaying the detailed information of the target objects. Optionally, the detailed information may be displayed in from of popping up a floating layer. The detailed information includes detailed address, character profile, costume prices and similar places, characters, costumes, etc.

The above-mentioned method for video playing, in steps S1-S4, firstly highlights brief information of the target object when the marker information with respect to the target object is included, and can directly highlight the contents of the marker information in a video. For example, the name of a scenic place, names of celebrities, costume brands and the like in a video can be highlighted. When a user is interested in the displayed information, detailed information of the target object is displayed when the request for displaying the detailed information of the target object is received, so as to simultaneously display the marker information with respect to the target object in a video in the process of playing the video, where the marker information is very likely to be desired important information for a video watcher, thereby greatly facilitating the user to obtain such important information when watching the video.

Optionally, as illustrated in FIG. 2, step S2 specifically includes: step S1′, determining whether a current frame includes a preset type of marker information with respect to a target object in a video playing process. The user can preset some types of interest, so as to filter out some marker information of unwanted types by determining whether the current frame includes a preset type of marker information with respect to the target object, thus improving the pertinency of displayed marker information and also preventing unnecessary interference with users. For example, if the preset type of the user is marker information of a character type, brief information of maker information of a character type will be highlighted in the current frame when the maker information of a character type is included.

Optionally, the above-mentioned step S1 specifically includes:

S1-1, acquiring duration time of video playing, which refers to the time of maintaining video playing from the beginning of the video playing to the current frame.

S1-2, determining whether the duration time is equal to the time when preset maker information appears. Step S1-3 will be performed when the duration time is equal to a time when the preset maker information appears; or step S1-4 will be performed when the duration time is not equal to the time when the preset maker information appears. There may be one or more of the time when the preset marker information appears. When there are many times when the present marker information appears, the duration time will be equal to the time when the preset marker information appears one by one along with the video playing, and then it can be determined that marker information is included successively, so as to successively display the brief information of the marker information in time sequence.

S1-3, acquiring determination result including the marker information with respect to the target object; and

S1-4, acquiring determination result excluding the marker information with respect to the target object;

The above-mentioned method for video playing obtains the determination result including the marker information when the duration time is equal to the time when the preset marker information appears, or obtains determination result excluding the marker information, and can successively display the brief information of the marker information along with the video playing, thus improving the operability.

Optionally, when receiving the request for displaying detailed information of the marker information, the method further includes a step of suspending the video playing. Therefore, when a user needs to know details of certain marker information, the user can suspend the video being played at present, thereby preventing the user from missing some contents of the video.

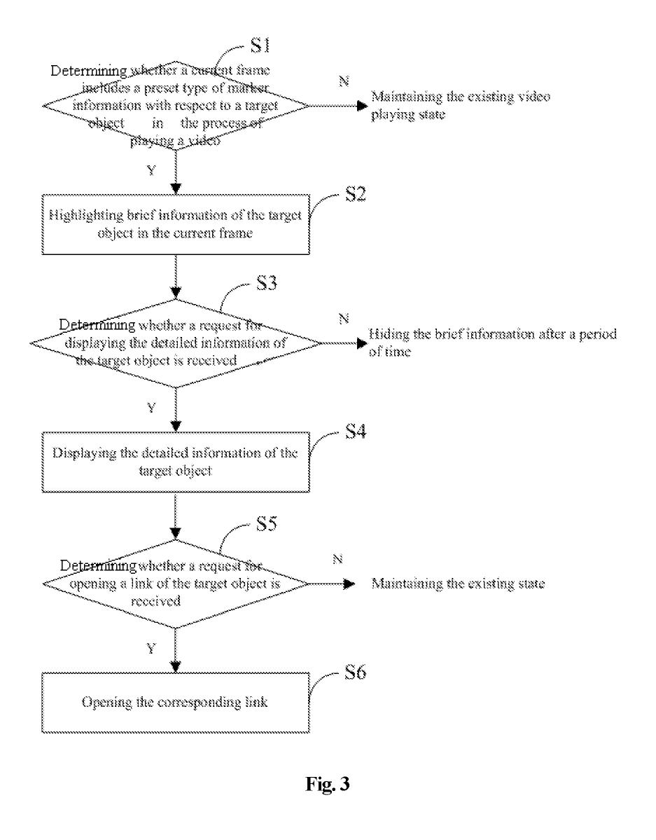

Optionally, the detailed information in step S4 includes a link of the target object. As shown in FIG. 3, after step 4 of displaying the detailed information of the target object, the following steps are further included:

S5, determining whether a request for opening a link of the target object is received. Step S6 will be performed when the request for opening the link of the target object is received; or the existing state will be maintained when the request for opening the link of the target object is not received. Optionally, a button for getting details may be set below a floating layer, and when a user clicks on the button, it is equivalent to having received the request for opening the link of the target object.

And S6, opening the corresponding link. The link may be a link for opening a travel platform APP or website, a link for opening the microblog of a character and the like, a link for opening a shopping website or APP, etc. For example, after opening a travel platform APP, the detailed information can be sent to the travel platform APP to further complete booking of air tickets and hotels, etc.

To the above-mentioned method for video playing, in steps S5-S6, opens a corresponding link when receiving the request for opening the link of the target object, so as to provide an interface for an external link, and further improve the convenience.

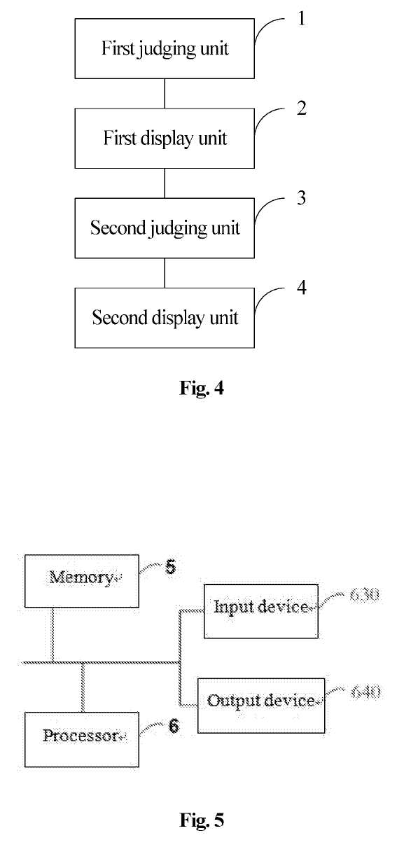

Corresponding to embodiment 1, the present embodiment provides a device for video playing, as shown in FIG. 4, including:

a first determining unit 1, for determining whether a current frame includes marker information with respect to a target object in a video playing process;

a first display unit 2, for highlighting brief information of the target object in the current frame when the current frame includes the marker information with respect to the target object;

a second determining unit 3, for determining whether a request for displaying detailed information of the target object is received; and

a second display unit 4, for displaying the detailed information of the target object when the request for displaying the detailed information of the target object is received.

According to the abovementioned device for video playing, by highlighting brief information of a target object in a current frame when marker information with respect to the target object is included, the contents of the marker information in a video can be directly highlighted. For example, the name of a scenic place, names of celebrities, costume brands and the like in a video can be highlighted; when a user is interested in the displayed information, detailed information of the target object is displayed when a request for displaying the detailed information of the target object is received, so that the marker information with respect to the target object in the video can be displayed in the process of playing the video, where the marker information is very likely to be desired important information for a video watcher, thereby greatly facilitating users to obtain such important information when watching the video.

Optionally, the first determining unit is specifically used for determining whether the current frame includes a preset type of marker information of the target object in a video playing process. A user can preset some types of interest, so as to filter out marker information of some unwanted types by determining whether the current frame includes a preset type of marker information with respect to the target object, thus improving the pertinency of displayed marker information and also preventing unnecessary interference with users.

Optionally, the first determining unit includes: an acquiring unit, for acquiring duration time of video playing; a third determining unit, for determining whether the duration time is equal to a time when preset marker information appears; a first determination result acquiring unit, for acquiring a determination result including the marker information with respect to the target object when the duration time is equal to the time when preset marker information appears; and a second determination result acquiring unit, for acquiring a determination result excluding the marker information with respect to the target object when the duration time is not equal to the time when preset marker information appears.

The abovementioned device for video playing acquires a determination result including the marker information when the duration time is equal to the time when preset marker information appears, or otherwise acquires a determination result excluding the marker information; and successively displays the brief information of the marker information with the playing of a video, thereby improving the operability.

Optionally, the detailed information includes a link of the target object, and after the second display unit, the device further includes: a fourth determining unit, for determining whether a request for opening the link of the target object is received; and a link opening unit, for opening the link when the request for opening the link of the target object is received.

According to the abovementioned device for video playing, when the request for opening the link of the target object is received, the corresponding link is opened, thereby providing an interface of an external link, and further improving the convenience.

The intelligent terminal according to the present embodiment includes the device for video playing in accordance with Embodiment 2. Therefore, the marker information appearing in a video can be displayed in a video playing process, where the marker information is very likely to be desired important information for a video watcher, thereby greatly facilitating the user to obtain such important information when watching the video.

The embodiments of this application disclose a non-volatile computer storage medium storing computer executable instructions which, when executed by the electronic device, enable the electronic device to: determine whether a current frame includes marker information with respect to a target object in a video playing process; highlight brief information of the target object in the current frame when the current frame includes the marker information with respect to the target object; determine whether a request for displaying detailed information of the target object is received; and display the detailed information of the target object when the request for displaying the detailed information of the target object is received.

Optionally, the step of determining whether the current frame includes the marker information with respect to the target object in a video playing process specifically means to determine whether the current frame includes a preset type of marker information with respect to the target object in a video playing process.

Optionally, the step of determining whether the current frame includes the marker information with respect to the target object in a video playing process includes: acquiring duration time of video playing; determining whether the duration time is equal to a time when preset marker information appears; acquiring a determination result including the marker information with respect to the target object when the duration time is equal to the time when preset marker information appears; and acquiring a determination result excluding the marker information with respect to the target object when the duration time is not equal to the time when preset marker information appears.

Optionally, the detailed information includes the link of the target object. Whether a request for opening the link of the target object is received can be further determined after the detailed information of the target object is displayed; and the link is opened when the request for opening the link of the target object is received.

FIG. 5 shows a schematic diagram of a hardware structure of an electronic device for executing the method for video playing provided by the embodiments of this application. As shown in FIG. 5, the device includes one or more processors 6 and a memory 5. One processor 6 is taken as an example in FIG. 5. The device for executing the method for video playing may further include an input device 630 and an output device 640.

The processor 6, the memory 5, the input device 630 and the output device 640 may be connected with a bus or in other ways, and bus connection is taken as an example in FIG. 5.

The memory 5, as a non-volatile computer readable storage medium, may be used for storing non-volatile software programs, non-volatile computer executable programs and modules, for example, program instructions/modules (e.g., a first determining unit 1, a second display unit 2, a second determining unit 3, and a second display unit 4 shown in FIG. 4) corresponding to the method for video playing in accordance with the embodiments of this application. The processor 6 runs the non-volatile software programs, instructions and modules stored in the memory 5, so as to execute various functional applications and data processing of a server, i.e., implementing the method for video playing in the abovementioned embodiments of the method.

The memory 5 may include a program storage area and a data storage area, where the program storage area may store an operating system and applications for at least one functions; and the data storage area may store data and the like created according to the use of the device for video playing. Moreover, the memory 5 may include a high-speed random access memory, and may also include a non-volatile memory, for example, at least one disk storage device, a flash memory, or other non-volatile solid storage devices. In some embodiments, the memory 5 optionally includes memories that are set remotely relative to the processor 6, and these remote memories may be connected to the device for video playing through a network. An example of the network includes, but is not limited to, internet, intranet, LAN, mobile communication network, and the combinations thereof

The input device 630 may receive input digit or character information, and generates a key signal input related to the user configuration and function control of the device for video playing. The output device 640 may include display devices such as a display screen.

The one or more modules are stored in the memory 5, and execute the method for video playing in any one of the abovementioned embodiments of the method, when executed by the one or more processors 6.

The abovementioned product can execute the method provided by the embodiments of this application and has corresponding functional modules and beneficial effects for executing the method. For the technical details that are not described in detail in this embodiment, please refer to the method provided by the embodiments of this application.

The electronic device of the embodiments of this application exists in many forms, including but not limited to:

(1) Mobile communication devices: the characteristics of such devices are that they have a mobile communication function with a main goal of enabling voice and data communication. Such terminals include: smart phones (such as iPhone), multimedia phones, feature phones, low-end phones, etc.

(2) Ultra-mobile personal computer devices: such devices belong to the category of personal computers, have computing and processing functions, and usually also have mobile internet access features. Such terminals include: PDA, MID, UMPC devices, etc., such as iPad.

(3) Portable entertainment devices: such devices are able to display and play multimedia contents. Such devices include: audio and video players (such as iPod), handheld game players, electronic books, intelligent toys, and portable vehicle navigation devices.

(4) Servers: devices providing computing services. The components of the servers include a processor, a hard disk, an internal memory, an electronic device bus, etc. The structures of the servers are similar to those of general purpose computers, but in order to provide highly reliable services, the servers have higher requirements in aspects of processing capability, stability, reliability, security, expandability, manageability, etc.

(5) Other electronic devices having data interaction functions.

The abovementioned embodiments of the device are only illustrative, where the units described as separate parts may be or may also not be physically separated, the components shown as units may be or may also not be physical units, i.e. may be located in one place, or may also be distributed to multiple network units. According to actual needs, part of or all of the modules may be selected to realize the objectives of the solution of the embodiment.

By abovementioned descriptions of the implementations, those skilled in the art can clearly understand that the various implementations may be implemented by software and a general hardware platform, or just by hardware. Based on such understanding, the abovementioned technical solution in essence, or the part thereof making a contribution to a related technology, may be embodied in the form of a software product, and such a computer software product may be stored in a computer readable storage medium such as an ROM/RAM, a magnetic disk or an optical disk, etc., and may include a number of instructions to enable a computer device (which may be a personal computer, a server, or a network device, or the like) to execute the method described in the various embodiments or in some parts thereof

Finally, it should be noted that: the abovementioned embodiments are merely illustrated for describing rather than limiting the technical solution of this application; although detailed description of this application is given with reference to the abovementioned embodiments, those skilled in the art should understand that they can still modify the technical solution recorded in the abovementioned various embodiments or replace part of the technical features therein with equivalents; and these modifications or replacements would not cause the essence of the corresponding technical solution to deviate from the spirit and scope of the technical solution of the various embodiments of this application.

What is claimed is:

1. A method for video playing, comprising the following steps:
applied to an electronic device;
determining whether a current frame comprises marker information with respect to a target object in a video playing process;
highlighting brief information of the target object in the current frame when the current frame comprises the marker information with respect to the target object;
determining whether a request for displaying detailed information of the target object is received; and
displaying the detailed information of the target object when the request for displaying the detailed information of the target object is received.

2. The method according to claim 1, wherein the step of determining whether a current frame comprises marker information with respect to a target is object in a video playing process specifically means to determine whether a current frame comprises a preset type of marker information with respect to a target object in a video playing process.

3. The method according to claim 1, wherein the step of determining whether a current frame comprises marker information with respect to a target object in a video playing process comprises:
acquiring duration time of video playing;
determining whether the during time is equal to the time when preset marker information appears;
and obtaining a determination result comprising the marker information with respect to the target object when the duration time is equal to the time when the preset marker information appears; or
obtaining a determination result excluding the marker information with respect to the target object when the duration time is not equal to the time when the preset marker information appears.

4. The method according to claim 1, wherein the detailed information comprises a link of the target object and after the step of displaying the detailed information of the target object, the method further comprises:
determining whether a request for opening the link of the target object is received; and
opening the link when the request for opening the link of the target object is received.

5. An electronic device, comprising:
at least one processor, and a memory in communication connection with the at least one processor, wherein the memory stores instructions that can be executed by the at least one processor, and the instructions are executed by the at least one processor to enable the at least one processor to:
determine whether a current frame comprises marker information with respect to a target object in a video playing process;
highlight brief information of the target object in the current frame when the current frame comprises the marker information with respect to the target object; determine whether a request for displaying detailed information of the target object is received; and
display the detailed information of the target object when the request for displaying the detailed information of the target object is received.

6. The electronic device according to claim 5, wherein determining whether the current frame comprises the marker information with respect to the target object in a video playing process specifically means to determine whether the current frame comprises a preset type of marker information with respect to the target object in a video playing process.

7. The electronic device according to claim 5, wherein the step of determining whether the current frame comprises the marker information with respect to the target object in a video playing process comprises: acquiring duration time of video playing; determining whether the duration time is equal to a time when preset marker information appears; and acquiring a determination result comprising the marker information with respect to the target object when the duration time is equal to the time when preset marker information appears; or
acquiring a determination result excluding the marker information with respect to the target object when the duration time is not equal to the time when preset marker information appears.

8. The electronic device according to claim 5, wherein the detailed information comprises a link of the target object, whether a request for opening the link of the target object is received can be further determined after the detailed information of the target object is displayed; and the link is opened when the request for opening the link of the target object is received.

9. A non-volatile computer storage medium storing computer executable instructions, wherein the computer executable instructions, when executed by an electronic device, enable the electronic device to:
determine whether a current frame comprises marker information with respect to a target object in a video playing process;
highlight brief information of the target object in the current frame when the current frame comprises the marker information with respect to the target object; determine whether a request for displaying detailed information of the target object is received; and
display the detailed information of the target object when the request for is displaying the detailed information of the target object is received.

10. The non-volatile computer storage medium according to claim 9, wherein the step of determining whether the current frame comprises the marker information with respect to the target object in a video playing process specifically means to determine whether the current frame comprises a preset type of marker information with respect to the target object in a video playing process.

11. The non-volatile computer storage medium according to claim 9, wherein the step of determining whether the current frame comprises the marker information with respect to the target object in a video playing process comprises: acquiring duration time of video playing; determining whether the duration time is equal to a time when preset marker information appears; acquiring a determination result comprising the marker information with respect to the target object when the duration time is equal to the time when the preset marker information appears; and acquiring a determination result excluding the marker information with respect to the target object when the duration time is not equal to the time when the preset marker information appears.

12. The non-volatile computer storage medium according to claim 9, wherein the detailed information comprises a link of the target object, and whether a request for opening the link of the target object is received can be further determined after the detailed information of the target object is displayed; and the link is opened when the request for opening the link of the target object is received.
